(19) United States
(12) Patent Application Publication
(10) Pub. No.: US 2010/0107974 A1
(43) Pub. Date: May 6, 2010

(54) SUBSTRATE HOLDER WITH VARYING DENSITY

(75) Inventors: Michael Givens, Phoenix, AZ (US); Mike Halpin, Scottsdale, AZ (US); Matthew G. Goodman, Chandler, AZ (US); Keir Kosco, Chandler, AZ (US)

Correspondence Address: Knobbe, Martens, Olson & Bear LLP, 2040 Main Street, 14th Floor, Irvine, CA, 92614, US

(73) Assignee: ASM AMERICA, INC., Phoenix, AZ (US)

(21) Appl. No.: 12/266,317

(22) Filed: Nov. 6, 2008

(51) Int. Cl. B05C 13/02

(52) U.S. Cl. 118/500

(57) ABSTRACT

A substrate support system comprises a substrate holder for supporting a substrate. The substrate holder comprises an interior portion sized and shaped to extend beneath most or all of a substrate supported on the substrate holder. The substrate holder has mass density that varies, preferably in order to compensate for variations in substrate temperature owing to surface geometry variations of the interior portion, so as to provide a more uniform thermal coupling between the substrate and substrate holder. The substrate holder is preferably configured to be spaced further apart from a substrate at the center than at the outer perimeter.

### BACKGROUND

1. Field of the Invention

The present invention relates to semiconductor substrate handling systems and, in particular, to systems and methods for supporting a substrate during material deposition processes.

2. Description of the Related Art

High-temperature ovens, or reactors, are used to process substrates for a variety of reasons. In the electronics industry, substrates, such as semiconductor wafers, are processed to form integrated circuits. In a reaction process, a substrate, typically a circular silicon wafer, is placed on a substrate holder. In some processes, the substrate holder helps to attract radiation and more evenly heat the substrate. These substrate holders are sometimes referred to as susceptors. The substrate and substrate holder are enclosed in a reaction chamber, typically made of quartz, and heated to high temperatures, typically by a plurality of radiant heat lamps placed around the quartz chamber.

In an exemplary high temperature process, a reactant gas is passed over the heated substrate, causing the chemical vapor deposition (“CVD”) of a thin layer of the reactant material onto a surface of the substrate. As used herein, the terms “processing gas,” “process gas,” and “reactant gas” generally refer to gases that contain substances, such as silicon-containing gases, to be deposited on a substrate. As used herein, these terms do not include cleaning gases. Through subsequent processes, the layers of reactant material deposited on the substrate are made into integrated circuits. The process gas flow over the substrate is often controlled to promote uniformity of deposition across the top or front side of the substrate. Deposition uniformity can be further promoted by rotating the substrate holder and substrate about a vertical center axis during deposition. As used herein, the “front side” of a substrate refers to the substrate's top surface, which typically faces away from the substrate holder during processing, and the “backside” of a substrate refers to the substrate's bottom surface, which typically faces the substrate holder during processing.

As mentioned above, a typical substrate to be processed is comprised of silicon. In the production of integrated circuits, it is sometimes desirable to deposit additional silicon, for example via CVD, onto the substrate surface(s). If the additional silicon is deposited directly onto the silicon surface of the substrate, the newly deposited silicon maintains the crystalline structure of the substrate. This type of deposition is known as epitaxial deposition. However, the surfaces of the original substrate to be processed are typically polished on both sides. When brought into contact with an oxygen environment, a native oxide layer, such as SiO₂, is formed on the substrate. A deposition of silicon onto the native oxide layer forms polysilicon deposits. In order to conduct epitaxial deposition, it is ordinarily necessary to remove the native oxide layer from each of the substrate's top and/or bottom surfaces onto which new silicon is to be deposited. The native oxide layer is typically removed by exposing it to a cleaning gas, such as hydrogen gas (H₂), at a sufficiently high temperature, prior to the deposition of additional silicon. As used herein, the term “cleaning gas” is different than and does not encompass reactant gases.

There are a large variety of different types of substrate holders for supporting a substrate during processing. A typical substrate holder comprises a body with a generally horizontal upper surface that receives and/or underlies the supported substrate. A spacer or spacer means is often provided for maintaining a small gap between the supported substrate and the horizontal upper surface of the substrate holder. This gap prevents process gases from causing the substrate to stick to the substrate holder. The substrate holder may include an interior portion that supports the substrate from below and an annular shoulder that closely surrounds the supported substrate. One type of spacer or spacer means comprises a spacer element fixed with respect to the substrate holder body, such as an annular lip, a plurality of small spacer lips, spacer pins or nubs, etc. An alternative type of spacer element comprises a plurality of vertically movable lift pins that extend through the substrate holder body and are controlled to support the position of the substrate above the upper surface of the substrate holder. Often, the spacer element is positioned to contact the substrate only within its “exclusion zone,” which is a radially outermost portion of the substrate within which it is difficult to maintain deposition uniformity. The exclusion zone is typically not used in the manufacturing of integrated circuits for commercial use, due to the non-uniformity of deposition there. A processed substrate may be characterized, for example, as having an exclusion zone of five millimeters from its edge.

One problem associated with CVD is the phenomenon of “backside deposition.” Many substrate holders are unsealed at the substrate perimeter so that process gases can flow down around the peripheral edge of the substrate and into the gap between the substrate and the substrate holder. These process gases tend to deposit on the substrate backside, both as nodules and as an annular ring at or near the substrate edge. This undesirable deposition creates non-uniformities in substrate thickness, generally detected by local site flatness tools. Such non-uniformities in substrate thickness can adversely affect chucking down of the substrate, and thus make impossible subsequent processing steps, such as photolithography.

One method for reducing backside deposition involves the use of a purge gas that flows upwardly from between the substrate holder and substrate and around the substrate edge to reduce the downward flow of cleaning or process gases. Conventional purge gas systems typically include gas flow channels to allow for the flow of purge gas through the substrate holder.

Another problem in semiconductor processing is known as autodoping. Autodoping can cause undesired variations in dopant concentration on the substrate, particularly in high-temperature epitaxial deposition processes. The formation of integrated circuits involves the deposition of dopant material, such as doped silicon, onto the front side of the substrate. Autodoping is the tendency of dopant atoms to diffuse downwardly through the substrate, emerge from the substrate backside, and then travel between the substrate and the substrate holder up around the substrate edge to redeposit onto the substrate front side, typically near the substrate edge. These redeposited dopant atoms adversely affect the performance of the integrated circuits, particularly semiconductor dies from near the substrate edge. Autodoping tends to be more prevalent and problematic for higher-doped substrates.

One method of reducing autodoping involves a susceptor that has a plurality of holes that permit the flow of gas between the regions above and below the susceptor. Autodoping is reduced by directing a flow of inert gas horizontally underneath the susceptor. Some of the gas flows upwardly through the holes of the susceptor into a gap region between the susceptor and a substrate supported by the susceptor. As diffused dopant atoms emerge at the substrate backside, they become swept away by the gas downwardly through the holes in the susceptor. In this way, the dopant atoms tend to get drawn down into the region below the susceptor.

### SUMMARY

In one aspect, a substrate support system has a substrate holder for supporting a substrate of a particular size in a supported position above an upper surface of an interior portion of the substrate holder. The upper surface of the interior portion has a substrate center alignment point configured to vertically align with a center of the substrate when the substrate is in the supported position on the substrate holder. The substrate center alignment point of the upper surface of the interior portion is configured to be spaced further apart from the substrate than an outer perimeter of the interior portion when the substrate is in the supported position on the substrate holder. A mass density of the interior portion varies along one or more radial lines extending from the substrate center alignment point of the interior portion.

In another aspect, a substrate support system includes a substrate holder for supporting a substrate. The substrate holder has a mass density that varies along a radius from a center of the substrate holder to an outer perimeter of the substrate holder. The substrate holder is formed of a porous material having a porosity between about 10%-40% and configured to allow gas flow therethrough.

In another aspect, a substrate support system comprises a substrate holder for supporting a substrate of a particular size in a defined supported position. The substrate holder comprises holes extending to and between upper and lower surfaces of the substrate holder. The substrate holder has a point configured to vertically align with a center of the particularly sized substrate when the substrate is in the supported position. The substrate holder has a mass density that decreases along a radius from the point to an outer annular location of the substrate holder.

### BRIEF DESCRIPTION OF THE DRAWINGS

These and other aspects of the invention will be readily apparent to the skilled artisan in view of the description below, the appended claims, and from the drawings, which are intended to illustrate and not to limit the invention, and wherein:

FIG. 1 is a schematic, cross-sectional view of an exemplary reaction chamber with a substrate supported on a substrate holder.

FIG. 2 is a schematic representation of a substrate supported on an embodiment of a substrate holder with a varying density.

FIG. 3 is a top view of a substrate holder according to one embodiment, wherein the mass density of the substrate holder varies radially by varying a hole density from a substrate center alignment point of the substrate holder.

FIG. 4 is a top view of a substrate holder according to another embodiment, wherein the substrate holder has three regions with different hole densities.

FIG. 5 is a top view of a substrate holder according to another embodiment, wherein the mass density of the substrate holder varies radially by varying a hole size from a substrate center alignment point of the substrate holder.

FIG. 6 is a top view of a substrate holder according to another embodiment, wherein the substrate holder has three regions with different hole sizes.

FIG. 7 is a cross-sectional view of an embodiment of a substrate holder wherein the mass density of the substrate holder varies radially by varying a recess density from a substrate center alignment point of the substrate holder.

FIG. 8 is a cross-sectional view of an embodiment of a substrate holder wherein the mass density of the substrate holder varies radially by varying the size of recesses from a substrate center alignment point of the substrate holder.

The drawings are not necessarily drawn to scale.

### DETAILED DESCRIPTION OF PREFERRED EMBODIMENTS

The following detailed description of the preferred embodiments and methods describes certain specific embodiments to assist in understanding the claims. However, one may practice the present invention in a multitude of different embodiments and methods as defined and covered by the claims.

Referring more specifically to the drawings for illustrative purposes, the present invention is embodied in the devices generally shown in the figures. It will be appreciated that the apparatuses may vary as to configuration and as to details of the parts, and that the methods may vary as to the specific steps and sequence, without departing from the basic concepts as disclosed herein.

Two problems to avoid in a substrate processing system are crystallographic slip and backside damage. Slip refers to the formation of crystal defects in the substrate, and is caused primarily by temperature variations across the substrate surface. Temperature variations can be reduced by minimizing the gap between the substrate and the substrate holder, particularly at the substrate's center. The thermal mass of the substrate holder is typically much larger than that of the substrate, such that the substrate holder temperature tends to be more uniform than the substrate temperature. Thermal gradients across the substrate are remedied to an extent by reducing the aforementioned gap between the substrate and the substrate holder so as to boost the thermal coupling of the two components.

Backside damage refers to damage that is caused by contact between the substrate backside and the substrate holder. As noted above, the substrate is typically supported on several spacers, which isolates and minimizes the contact between the substrate and the substrate holder. Typically, the spacers are located near the edge of a supported substrate, because the edge portion of the substrate (sometimes referred to as the “exclusion zone”) is often not used in the formation of integrated circuits. Unfortunately, the substrate often tends to bow or warp slightly when supported by the substrate holder, for example, when the substrate is being heated after loading, due to temperature gradients across the substrate surface. Notwithstanding the use of the spacers, the substrate's bowing or warping can cause it to contact the upper surface of the substrate holder, particularly at or near the center of the substrate. One approach to preventing consequent backside damage is to increase the size of the gap between the substrate and the substrate holder by increasing the height of the spacers. Another approach is to use a substrate holder with a concave upper surface, and to use a concavity depth that is sufficient to avoid contact between the substrate and the substrate holder caused by bowing or warping of the substrate. Substrate holders with concavities often still include spacers that support the substrate.

Unfortunately, these approaches to preventing crystallographic slip and backside damage oppose one another. That is, increasing the gap between the center of the substrate and the substrate holder decreases the risk of backside damage but increases the risk of crystallographic slip due to temperature gradients across the substrate. In substrate holders with concave upper surfaces, temperature gradients occur because the edge region of the substrate is closer to the substrate holder than the center of the substrate. Regardless of whether the substrate holder has a concavity, temperature gradients are also caused due to the contact between the substrate and the spacers. The heightened gap reduces the thermal coupling between the substrate holder and the substrate, which makes it easier for temperature gradients to exist.

Hence there is a need for reducing both crystallographic slip and backside damage simultaneously. One way of doing this is with a substrate holder having a concave shape, so as to avoid backside damage, while also varying the thermal coupling between the substrate holder and the substrate 16, so as to reduce the risk of temperature gradients within the substrate. One way of varying the thermal coupling is by varying the thermal mass density of the substrate holder. As used herein, thermal mass is related to how quickly or slowly a material or structure reacts to temperature variations. Hence, a substrate holder with a high thermal mass will react slowly to temperature variations. As used herein, thermal mass density is a measure of thermal mass per unit volume of the substrate holder. The thermal mass of the substrate holder may depend on, among other factors, the mass density of the substrate holder. Accordingly, the present application discloses several embodiments of substrate holders whose mass density varies to compensate for variations in surface geometry of the substrate holder, such as a concavity, in order to provide a substantially uniform thermal coupling between the substrate holder and a substrate supported thereon.

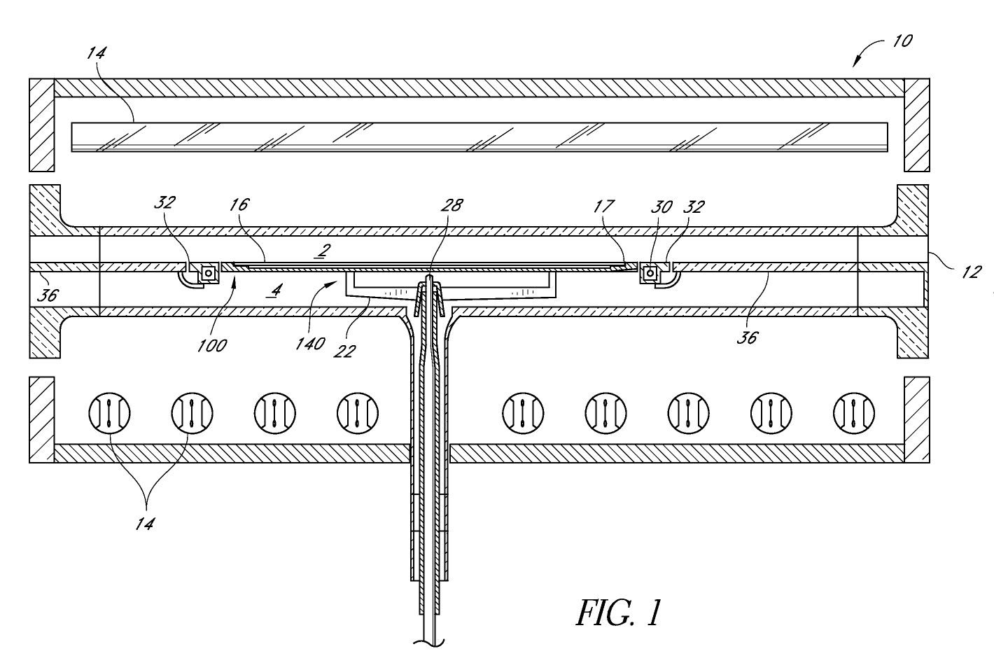

Prior to describing certain embodiments of the substrate holder, an exemplary CVD reactor is disclosed. FIG. 1 illustrates an exemplary CVD reactor 10, including a quartz reaction chamber 12. Radiant heating elements 14 are supported outside the transparent chamber 12 to provide heat energy to the chamber 12 without appreciable absorption by the chamber walls. Although the embodiments are described in the context of a “cold wall” CVD reactor, it will be understood that the substrate support systems described herein can be used in other types of reactors and semiconductor processing equipment. Skilled artisans will appreciate that the invention is not limited to use within the particular reactor 10 disclosed herein. In particular, one of ordinary skill in the art can find application for the substrate support systems described herein for other semiconductor processing equipment, wherein a substrate is supported while being heated, cooled, or processed. Moreover, while illustrated in the context of standard silicon wafers, the substrate holders described herein can be used to support other kinds of substrates, such as glass substrates which are subjected to treatments, such as CVD, physical vapor deposition (“PVD”), etching, annealing, dopant diffusion, or photolithography. The substrate holders are of particular utility for supporting substrates during treatment processes at elevated temperatures. Also, skilled artisans will appreciate that the embodiments described herein include substrate holders that are susceptors as well as those that are not susceptors.

The radiant heating elements 14 typically include two banks of elongated tube-type heating lamps arranged in orthogonal or crossed directions above and below a substrate holder holding a substrate 16. Each of the upper and lower surfaces of the substrate can face one of the two banks of heating lamps 14. According to an embodiment, a controller within the thermal reactor adjusts the relative power to each lamp 14 to maintain a desired temperature during substrate processing.

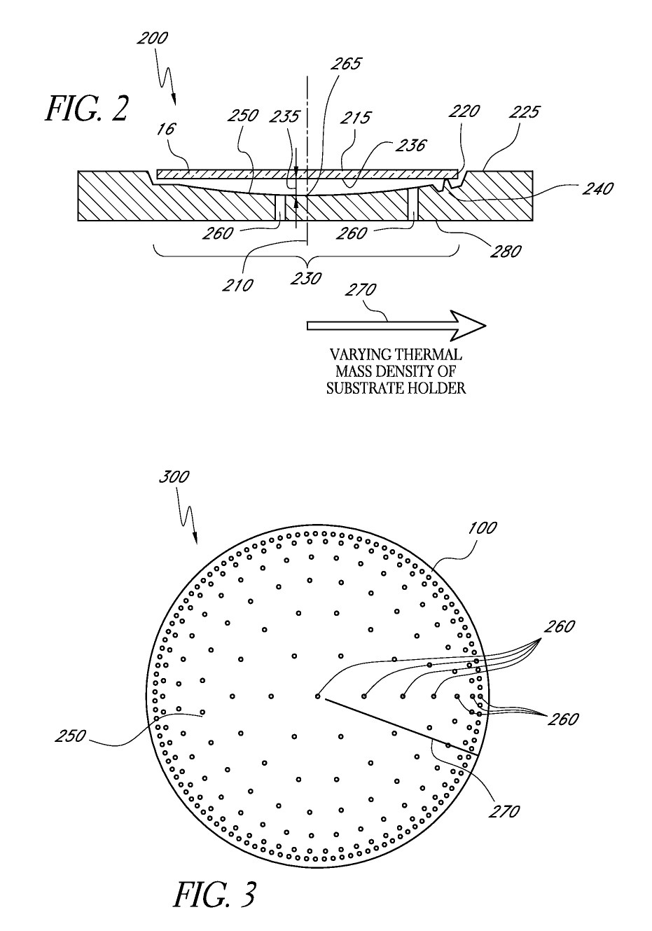

The illustrated substrate 16 includes a generally circular edge 17, shown in FIG. 1, supported within the reaction chamber 12 upon a substrate support system 140. The illustrated substrate support system 140 includes a substrate holder 100, upon which the substrate 16 rests, and a spider 22 that supports the substrate holder 100. Several embodiments of the substrate holder 100 are shown in greater detail in FIGS. 2-8, which are described below. The spider 22 can be formed of a transparent and non-metallic material. The skilled artisan will appreciate that the non-metallic aspect of the material helps to reduce contamination. The spider 22 may have arms 148 that are configured to support the bottom surface of the substrate holder 100. In certain embodiments, the spider 22 can be hollow and capable of conveying a sweep gas upward through holes of the substrate holder 100. Examples of hollow spiders used in conjunction with perforated substrate holders are disclosed in U.S. Patent Publication No. 2005-0193952 and in U.S. patent application Ser. No. 12/116,114, filed on May 6, 2008.

In an embodiment, the substrate holder 100 comprises a susceptor capable of absorbing radiant energy from the heating elements 14 and re-radiating such energy. The substrate holder 100 can be solid and formed of a single piece. Alternatively, the substrate holder 100 can be formed of multiple pieces that are assembled or attached together, such as pieces comprising an interior portion and one or more surrounding concentric annular portions, as described below. According to an embodiment, the spider 22 and the substrate holder 100 may be configured to rotate in unison about a vertical center axis during substrate processing.

Temperature sensors or thermocouples 28, 30 may be provided for sensing the temperature at the center of the substrate holder 100. The thermocouples 28, 30 may be connected to a temperature controller (not shown), which controls and sets the power of the various radiant heating elements 14 in response to the temperature readings of the thermocouples 28, 30.

A slip ring 32 may be configured to absorb radiant heat during high temperature processing. The heated slip ring 32 helps to reduce heat loss at the substrate edge 17. As illustrated, the dividers 36 divide the reactor 10 into an upper chamber 2 designed for the flow of reactant or process gases, for example for CVD on the substrate surface, and a lower chamber 4. The dividers 36 and other elements of the reactor 10 can substantially prevent fluid communication between the chambers 2 and 4. However, because the substrate holder 100 can be rotatable about a vertical center axis, a small clearance typically exists between the substrate holder 100 and the slip ring 32 or other elements. Thus, it is often difficult to completely prevent fluid communication between the upper chamber 2 and the lower chamber 4. This problem is typically addressed by creating a pressure differential between the chambers 2, 4, such that pressure is higher in the lower chamber 4 to inhibit downward flow of gases from the upper chamber 2 to the lower chamber 4. While FIG. 1 depicts the substrate 100 within an exemplary CVD reactor, the various embodiments of substrate holders disclosed herein may apply to rapid thermal annealing systems and other non-deposition applications where control of heating is desirable.

FIG. 2 depicts a schematic cross section of a substrate holder 200 with a varying density, for supporting a substrate 16. In various embodiments, the substrate holder 200 has a thermal mass density that varies across the substrate holder 200. For example, in some embodiments, the thermal mass density may vary along one or more radial lines extending from the center 210 of the substrate holder 200. This makes it possible to compensate for temperature gradients that would otherwise occur across the substrate surface, such as gradients caused by the concave upper surface of the illustrated holder 200. The ability to compensate for temperature gradients in turn makes it possible to increase the gap between the substrate 16 and the substrate holder 200 at the center of the substrate, thereby reducing the risk of backside damage to the substrate. Hence, as illustrated in FIG. 2, the substrate holder 200 may be configured to be spaced further apart from the substrate 16 at the center of the substrate 16 than at the outer perimeter 220 of the substrate 16 when the substrate 16 is supported by the substrate holder 200.

For example, substrate holder 200 may comprise an interior portion 230 that underlies a supported substrate 16. The interior portion 230 may be configured to support a substrate 16 from below. The substrate holder 200 may also comprise one or more spacers or supports 240 that contact the backside 236 of the substrate 16 from below the substrate 16. There may be three such supports 240, each angularly spaced about 120° apart from the other (and hence only one is shown in the cross section of FIG. 2), however, other configurations are possible. For example, the supports 240 may comprise an annular lip formed near the outer perimeter 220 of much of the interior portion 230 of the substrate holder 200. The top surface 250 of the interior portion 230 may be generally concave in shape. In alternative embodiments, the top surface 250 can be substantially conical, with a lower vertex at the center 210 (or substrate center alignment point 265, described below, if it is different than the center 210) of the substrate holder 200. As illustrated in FIG. 2, the top surface 250 is substantially concave, although other surface profiles are possible. For example, the top surface 280 may comprise curved surfaces of varying curvature or the top surface 280 may comprise different annular regions of different frustoconical shapes.

In some embodiments, a substrate center alignment point 265 of the substrate holder 200 may be configured to substantially vertically align with a center 215 of the substrate 16 when the substrate is supported by the substrate holder 200 in a substantially horizontal position of the substrate. The location 265 can be the center 210 of the substrate holder 200, as in the illustrated embodiment, or alternatively offset from the center 210.

As illustrated in FIG. 2, the interior portion 230 and the substrate holder 200 have a common center 210. However, this is not necessary. The thermal mass density may vary along paths extending radially from the center 210 to the outer perimeter 220 of the interior portion 230. In some embodiments, the thermal mass density may vary radially from the center 210 along the entirety of the interior portion of the substrate holder 200, i.e., along each radial direction. The thermal mass density profile may be axisymmetric about the center 210 or substrate center alignment point 265. That is to say that the thermal mass density may be substantially uniform at any given radial distance from the center of the interior portion 230. In other embodiments, the thermal mass density may be non-axisymmetric. The thermal mass density may decrease from the center 210 of the interior portion 230 to the outer perimeter 220 of the interior portion 230. The thermal mass density variation may be substantially gradual and/or linear along each radial line. Alternatively, the thermal mass density may vary in discrete steps, such as by providing multiple radial sections with different substantially uniform thermal mass densities. One of ordinary skill in the art will appreciate that various thermal mass density variation profiles may be utilized to minimize the occurrence of temperature gradients across the substrate 16. For example, the thermal mass density may be very small in areas close to or around the supports 240, where the substrate holder 200 actually contacts and supports the substrate 16.

One way of varying the thermal mass density is by varying the mass density of the substrate holder 200. Hence, in various different embodiments, the mass density may decrease along lines extending radially from the center 210 or location 265 of the interior portion 230 of the substrate holder 200. The substrate holder 200 is preferably configured to have a mass density that decreases along a radius from the center 210 or location 265 to the outer annular shoulder 225. The mass density may vary substantially gradually, linearly, and/or continuously. Alternatively, it can vary non-smoothly as described above. That is to say that the mass density may be different in different distinct regions of the substrate holder 200. In some embodiments, the mass density may be greater near the center of the interior portion 230 of the substrate holder 200 than near the outer perimeter 220 of the interior portion 230 of the substrate holder 200. In yet other embodiments, the mass density may be greatest at or near the center 210 or location 265 of the interior portion 230 of the substrate holder 200, with the mass density varying as desired along the radius 270 out to the outer perimeter 220 of the interior portion 230. For example, the mass density may be anywhere from 10% to 100% of the nominal mass density of the bulk solid material from which the interior portion of the substrate holder is formed. Therefore, in some embodiments, the mass density near the center 210 of the substrate holder 200 may be equal to the mass density of the bulk solid material. The mass density may be varied to be a fraction of the nominal mass density of the bulk solid material at various points along a radius 270 away from the center 210 as desired.

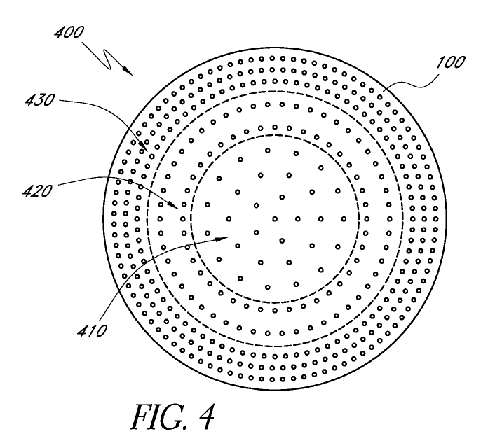

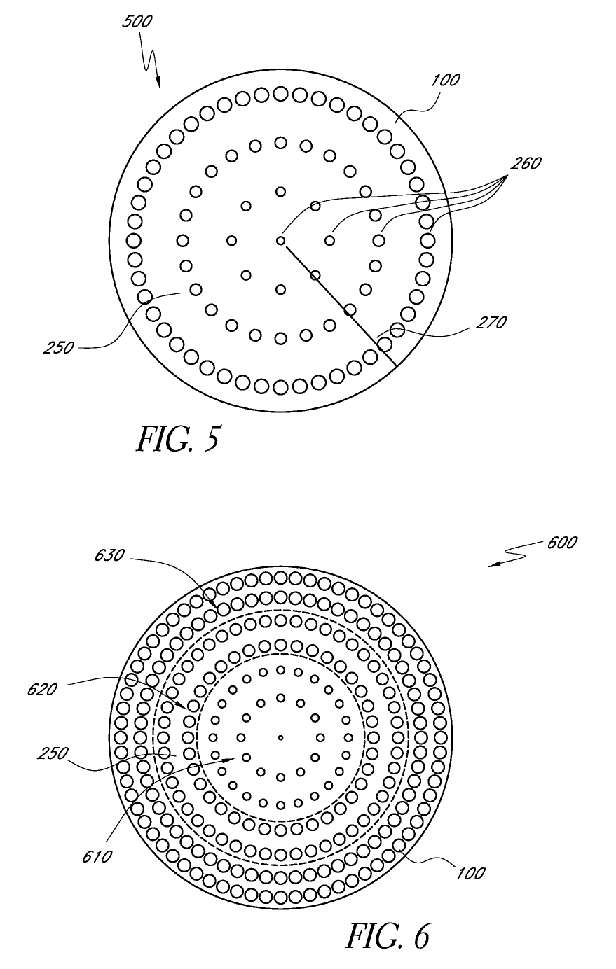

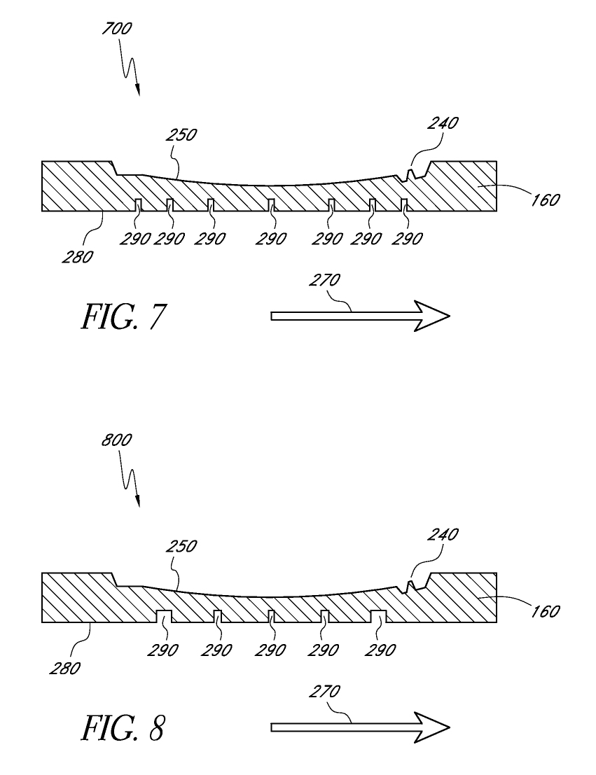

In some embodiments, the substrate holder 200 may comprise holes 260 each extending from the top surface 250 to a bottom surface 280 of the holder 200. The substrate holder 200 may also have an outer annular shoulder 225 configured to extend slightly beyond an outer perimeter or edge 17 of the substrate 16. The mass density may vary by varying a density of the holes 260 (see FIGS. 3 and 4) along a radius from the location 265 to the outer annular shoulder 225. Alternatively, the mass density can be varied by varying a size of the holes (see FIGS. 5 and 6). Similarly, the mass density may be varied by varying a density or size of recesses provided in place of the holes 260 (see FIGS. 7 and 8). As used herein, a hole or recess density is the number of holes or recesses per unit area of top surface 250 or bottom surface 280. The holes or recesses may all be of an equal size, or may vary in size.

One way to vary the mass density of the substrate holder 200 is to vary the hole density along the radius 270 of the interior portion 230 of the substrate holder 200. The density of the holes 260, or the hole density, can vary substantially gradually, linearly, and/or continuously. Alternatively, multiple discrete radial sections can have different substantially uniform hole densities. FIGS. 3 and 4 show schematic top views substrate holders 300, 400 having a hole density that varies along a radius 270. The variation in the hole density, and hence the mass density, may be in the interior portion or across the entire substrate holder 300, 400. In the embodiment of FIG. 3, the holes 260 are preferably all of an equal size, although the hole density varies across the substrate holder 300. FIG. 3 illustrates a substrate holder 300, whose mass density is varied by varying the hole density gradually. As illustrated in FIG. 3, the hole density varies substantially continuously, and preferably substantially axisymmetrically, along the radius 270 of the substrate holder 300. FIG. 4 illustrates a substrate holder 400 whose mass density is varied by varying the hole density in multiple discrete central and radial/annular sections. For example, the illustrated substrate holder 400 comprises a central circular region 410 having a first substantially uniform hole density and an annular region 420 surrounding the central region 410, the annular region 420 having a second substantially uniform hole density that is different from the first hole density. Annular region 420 may extend to the outer perimeter 220 (FIG. 2) of the substrate 16 or may be surrounded by another annular region 430, as illustrated, having a third substantially uniform hole density that is different from the first and second hole densities. In other embodiments, the substrate holder 400 may comprise a central circular region 410 having a first substantially uniform hole density and a plurality of substantially concentric annular regions 420, 430, etc. surrounding the central region 410, the annular regions 420, 430, etc. each having a substantially uniform hole density that is different from the first hole density. The hole densities of the annular regions 420, 430, etc. may also be different from each other.

Another way to vary the mass density of the substrate holder 200 is to vary the size of the holes 260 along the radius 270. The hole size can vary substantially gradually, linearly, and/or continuously. Alternatively, multiple discrete radial/annular sections can have differently sized holes. FIGS. 5 and 6 show schematic top views of substrate holders 500, 600 having a hole size that varies along a radius 270. The variation in the hole size, and hence the mass density of the substrate holder, may be in the interior portion or across the entire substrate holder 500, 600. FIG. 5 illustrates a substrate holder 500, where the mass density is varied by varying the hole size gradually or smoothly. As illustrated in FIG. 5, the hole size varies substantially gradually and continuously along the radius 270 of the substrate holder 500. FIG. 6 illustrates a substrate holder 600, where the mass density is varied by varying the hole size in a central section and one or more annular sections surrounding the central section. For example, the illustrated substrate holder 600 comprises a central circular region 610 where the holes 260 have a substantially uniform first hole size and an annular region 620 surrounding the central region 610, the annular region 620 having holes with a substantially uniform second hole size that is different from the first hole size. Annular region 620 may extend to the outer perimeter 220 (FIG. 2) of the substrate 16 or may be surrounded by another annular region 630 having a third substantially uniform hole size that is different from the first and second hole sizes. In other embodiments, the substrate holder 600 may comprise a central circular region 610 where the holes 260 have a substantially uniform first hole size and a plurality of substantially concentric annular regions 620, 630, etc. surrounding the central region 610, the annular regions 620, 630, etc. each having holes 260 with a substantially uniform hole size that is different from the first hole size. The hole sizes of the annular regions 620, 630, etc. may also be different from each other.

The holes 260 of FIGS. 3-6 may be of a suitable size for the purposes described herein. While the size of the holes 260 is shown quite large (as in FIGS. 5 and 6), it will be understood that this is done for the purpose of illustration, and that the holes may be smaller or even larger than depicted, as required. In some embodiments, each of the holes 260 in the interior portion 230 of the substrate holder have only one upper end at the upper surface 250 of the substrate holder and only one lower end at the lower surface 280 of the substrate holder, wherein none of the holes 260 are connected to any others of the holes 260.

The holes 260 of FIGS. 3-6 may help to prevent autodoping, as discussed previously. Sometimes the holes can result in the direct impingement of relatively focused, high velocity flows of purge gas onto the substrate backside. These focused, high velocity flows of purge gas onto the substrate backside can cause localized cooling or “cold spots” in the substrate, which adversely affect the uniformity of deposited materials on the substrate. Hence, an alternative approach to preventing autodoping is to form the substrate holder 200 from a porous material that allows diffused dopant atoms to flow downwardly through the substrate holder 200, without providing through holes 260. Hence, in an embodiment, the substrate holder 200, or the interior portion 230 of the substrate holder 200, may comprise a porous material, such as a material that is sponge-like yet rigid, having a porosity of greater than 10%, or within 10-40%.

In embodiments where the substrate holder 200 (FIG. 2) comprises a porous material, it may be desirable to vary the thermal mass density along the radius 270 of the substrate holder 200. Hence, in various embodiments, the substrate holder 200 has a mass density that varies, preferably axisymmetrically, along a radius 270 from the center 210 or substrate center alignment point 265 of the substrate holder, wherein the substrate holder 200 is formed of a material having a porosity preferably between about 10%-40% and configured to allow gas flow therethrough. In some embodiments, the mass density of the porous material may be varied by varying the porosity of the material across the substrate holder. In such embodiments, the through holes 260 are preferably omitted.

With reference to FIGS. 2, 7, and 8, in embodiments where the substrate holder 200 comprises a porous material, the substrate holder 200 may comprise recesses 290 defining thinned portions to provide for easier diffusion of gas through the porous material. Such recesses 290 may be provided as an alternative to the holes 260 described above. Recesses 290 may be formed in the interior portion 230 of the substrate holder 200, or alternatively throughout the substrate holder 200. Porous material substrate holders with recesses for defining thinned portions are more fully described in U.S. patent application Ser. No. 12/116,114, filed May 6, 2008. As discussed above with respect to holes 260, the mass density of the interior portion 230 of the substrate holder can be varied by varying the density and/or size of the recesses 290. The density and/or size of the recesses 290 may vary substantially gradually, linearly, smoothly, and/or continuously along the radius of the substrate holder 200. In other embodiments, the mass density of the porous material may vary discontinuously, such as by discontinuously varying the density and/or size of recesses 290.

As used herein, a “porous material” refers to a material that is inherently porous and gas-permeable. Thus a substrate holder formed of a “porous material” is gas-permeable regardless of the presence or non-presence of the man-made holes 260 formed within the substrate holder 200. In one embodiment, the porosity of the porous material is between about 10-40%. In another embodiment, the porosity of the porous material is between about 20-30%. Such porosity of the substrate holder 200 allows sufficient flow therethrough of gas in thinned portions formed by recesses or cut-outs 290 in the upper surface 250 or lower surface 280. Such gas flow prevents or reduces backside deposition and autodoping, as described above. According to an embodiment, the porous material is a composite silicon carbide material, such as one available from XyCarb Ceramics/Schunck Semiconductor of The Netherlands. In an embodiment, the porous material has a density in a range of about 0.5-1.5 g/cm³, such as about 1.0 g/cm³. In some embodiments, the mass density varies along a radius from the center 210 or substrate center alignment point 265 of the interior portion 230 to the outer perimeter of the substrate holder.

FIGS. 7 and 8 respectively show embodiments of substrate holders 700 and 800 formed of a porous material. The interior portion of the substrate holder 700, 800 includes a plurality of recesses or cut-outs 290 to produce thinned portions of the substrate holder 700, 800 for facilitating fluid flow through the substrate holder. It will be understood that a recess 290 is a cut-out, hole, or opening that does not extend completely through the substrate holder 700, 800. It is understood that although the recesses or cut-outs 290 are illustrated as being formed on the lower surface 710, the recesses 290 may also be formed on the upper surface 250 of the substrate holder as well, or even on both the upper and lower surfaces. The recesses 290 interior portion may have various shapes and sizes.

It will be understood that in embodiments using a porous material, the thinned portions defined by recesses 290 allow a sufficient amount of gas, such as cleaning gas, purge gas, etc., to flow though the substrate holder 700, 800 to reduce or prevent backside deposition as well as autodoping. The skilled artisan will also readily appreciate that recesses 290, in combination with the porous material, allow gas flow through the substrate holder 700, 800, but do not allow direct gas flow on the backside of the substrate. As discussed above, direct impingement of relatively focused, high velocity flows onto the substrate backside can cause localized cooling or “cold spots” in the substrate, which adversely affect the uniformity of deposited materials on the substrate. Furthermore, the skilled artisan will appreciate that a substrate holder formed of the porous material has less thermal mass than a conventional substrate holder formed of a non-porous material, thereby increasing throughput as well as slip performance. Radial variation of the mass density of the substrate holder 700, 800 may further reduce the possibility of temperature gradients, thereby enhancing slip performance even further.

FIGS. 7 and 8 depict schematic cross-sectional views of a substrate holder wherein the mass density is varied across the substrate holder 700, 800 by varying the density or size of the recesses 290. The substrate holder 700, 800 may comprise a porous material, although it is understood that in other embodiments, substrate holder 700, 800 may be formed of a non-porous material. For example, the substrate holder may not be designed for sweep gas flow, in which case the recesses 290 do not convey gas through the holder. The variation in the recess 290 density or size may be in the interior portion or across the entire substrate holder 700, 800. FIG. 7 illustrates a substrate holder 700 in which the mass density is varied by varying the density of the recesses, i.e., the number of recesses 290 per unit area of surface 250 or surface 280. As explained with reference to FIGS. 3 and 4, the hole 260 density may be varied gradually, linearly, continuously, or non-smoothly by providing a central section and one or more surrounding annular sections with different substantially uniform hole 260 densities. Similarly, the recess 290 density may be varied in ways similar to those described above. Hence, in the embodiment illustrated in FIG. 7, the mass density is varied by gradually varying the density of the recesses 290 along the radius 270 of the substrate holder 700. In other embodiments, the substrate holder 700 may comprise a central circular region where the recesses 290 have a substantially uniform first recess density and an annular region surrounding the central region, the annular region having a substantially uniform second recess density that is different from the first recess density (as illustrated in FIG. 4 with respect to the holes 260). In yet other embodiments, the substrate holder 700 may comprise a central circular region with a substantially uniform first recess density and a plurality of concentric annular regions surrounding the central region, the annular regions each having a substantially uniform recess density that is different from the first recess density. The recess densities of the annular regions may also be different from each other. The recess 290 density is preferably axisymmetric.

FIG. 8 illustrates a substrate holder 800, where the mass density is varied by varying the recess 290 size. As illustrated in FIG. 8, the mass density may be varied by varying the size of the recesses 290 gradually, linearly, and/or continuously along the radius 270 of the substrate holder. In other embodiments, the substrate holder 800 may comprise a central circular region where the recesses 290 have a substantially uniform first size and an annular region surrounding the central region, the annular region having recesses 290 with a substantially uniform second recess size that is different from the first recess size. In yet other embodiments, the substrate holder 800 may comprise a central circular region with a substantially uniform first recess size and a plurality of concentric annular regions surrounding the central region, the annular regions each having recesses 290 with a substantially uniform recess size that is different from the first recess size. The recess 290 sizes of the annular regions may also be different from each other.

The arrangement of holes 260 or recesses 290 may be axisymmetric with respect to the center axis of the substrate holder 200. Any suitable number of holes 260 or recesses 290 may be provided. It will be understood that there are a great variety of possible arrangements of the holes 260 or recesses 290, and that the illustrated arrangements are merely possibilities. In some embodiments, about 20-80% of an upper 250 or lower 280 surface of the substrate holder 200 has such holes 260 or recesses 290.

The holes 260 and recesses 290 can have cross-sections of various shapes. In practice, it is relatively easier to produce holes and recesses with circular cross-sections, by conventional drilling. Hence the holes 260 and recesses 290 may have diameters ranging from 0.1 mm to 5 mm. In certain embodiments with recesses 290, where the recesses 290 define thinned portions of the substrate holder, each of the thinned portions is no thicker than 90% of the total substrate holder thickness at that location, i.e., less than 90% of the thickness of the substrate holder immediately surrounding the recess defining the thinned portion.

In various other embodiments, the holes 260 or recesses 290 may radially vary in density or size linearly from the center 210 or location 265 of the substrate holder. In other words, the size or density varies linearly with displacement from the center 210 or substrate center alignment point 265. The diameter of the holes 260 or recesses 290 can be determined, in part, based upon empirical haze and resistivity results, as well as, for example, the desired flow rate of the gas passing through the interior portion 230. Additionally, the holes 260 or recesses 290 can be similar to or different than one another, as desired.

The skilled artisan will appreciate that various arrangements of the holes 260 or recesses 290 in the substrate holder are possible and are preferably optimized for strength as well as process control, for example, reducing haze/halo problem, resistivity, slip, nanotopography, etc. Furthermore, the spider 22 (see FIG. 1) can be hollow and can convey sweep gas into the holes 260 or recesses 290 of the embodiments described above.

The skilled artisan will also recognize that a substrate holder 200 with varying thermal mass density may be used to tailor effective thermal coupling, and the resultant substrate thermal profile, to compensate for non-uniformities other than a concavity in the top surface 250 of the substrate holder 200. The non-uniformities may result from masses or structures within a chamber or from process effects. For example, the variation in mass density of the substrate holder 200 could be made to be non-axisymmetric in order to non-axisymmetrically tailor the thermal coupling between the substrate holder 200 and the substrate 16 in order to achieve a nominally uniform temperature profile on a non-rotated wafer. This may be desirable, for example, to compensate for a system-specific non-rotated thermal “signature.”

Furthermore, the skilled artisan will recognize the interchangeability of various features from different embodiments. Similarly, the various features and steps discussed above, as well as other known equivalents for each such feature or step, can be mixed and matched by one of ordinary skill in this art to perform methods in accordance with principles described herein.

Although this invention has been disclosed in the context of certain embodiments and examples, it will be understood by those skilled in the art that the present invention extends beyond the specifically disclosed embodiments to other alternative embodiments and/or uses of the invention and obvious modification thereof Thus, it is intended that the scope of the present invention herein disclosed should not be limited by the particular disclosed embodiments described above, but should be determined only by a fair reading of the claims that follow.

What is claimed is:

1. A substrate support system comprising a substrate holder for supporting a substrate of a particular size in a supported position above an upper surface of an interior portion of the substrate holder, the upper surface of the interior portion having a substrate center alignment point configured to vertically align with a center of the substrate when the substrate is in the supported position on the substrate holder, wherein the substrate center alignment point of the upper surface of the interior portion is configured to be spaced further apart from the substrate than an outer perimeter of the interior portion when the substrate is in the supported position on the substrate holder, and wherein a mass density of the interior portion varies along one or more radial lines extending from the substrate center alignment point of the interior portion.

2. The substrate support system of claim 1, wherein the mass density is substantially uniform at any given radial distance from the substrate center alignment point of the upper surface of the interior portion.

3. The substrate support system of claim 1, wherein the interior portion of the substrate holder comprises holes that extend from the upper surface of the interior portion to a bottom surface of the interior portion, the holes permitting gas flow through the interior portion.

4. The substrate support system of claim 3, wherein the variation of the mass density is caused by a variation of a density of the holes.

5. The substrate support system of claim 4, wherein sizes of each of the holes are substantially equal.

6. The substrate support system of claim 3, wherein the mass density decreases from the substrate center alignment point to the outer perimeter of the interior portion.

7. The substrate support system of claim 3, wherein the substrate holder comprises a central circular region having a substantially uniform first hole density and an annular region surrounding the central region, the annular region having a substantially uniform second hole density that is different from the first hole density.

8. The substrate support system of claim 3, wherein each of the holes in the interior portion of the substrate holder has only one upper end at the upper surface of the substrate holder and only one lower end at the lower surface of the substrate holder, wherein none of the holes are connected to any others of the holes.

9. The substrate support system of claim 3, wherein the variation of the mass density is caused by a variation of sizes of the holes.

10. The substrate support system of claim 9, wherein the mass density is greater near the substrate center alignment point of the interior portion than near the outer perimeter of the interior portion.

11. The substrate support system of claim 3, wherein the substrate holder comprises a central circular region having holes of a substantially uniform first size and an annular region surrounding the central region, the annular region having holes of a substantially uniform second size that is different than the first size.

12. The substrate support system of claim 1, wherein the interior portion comprises a central circular region having a substantially uniform first mass density and an annular region surrounding the central region, the annular region having a substantially uniform second mass density that is different than the first mass density.

13. The substrate support system of claim 1, wherein the variation of the mass density is substantially smooth, along said one or more radial lines.

14. The substrate support system of claim 13, wherein the mass density of the interior portion decreases starting from the substrate center alignment point of the interior portion along said one or more radial lines.

15. The substrate support system of claim 1, wherein the variation of the mass density is substantially linear.

16. The substrate support system of claim 1, wherein the variation of the mass density is continuous.

17. The substrate support system of claim 1, wherein the interior portion of the substrate holder is formed of a material having a porosity of greater than 10%.

18. The substrate support system of claim 17, wherein the variation of the mass density is caused by a variation of the porosity of the material.

19. The substrate support system of claim 17, wherein the interior portion of the substrate holder includes recesses defining thinned portions of the interior portion.

20. The substrate support system of claim 19, wherein the variation of the mass density is caused by a variation of a density of the recesses along said one or more radial lines.

21. The substrate support system of claim 19, wherein the variation of the mass density is caused by a variation of sizes of the recesses along said one or more radial lines.

22. The substrate support system of claim 1, wherein the upper surface of the interior portion is concave.

23. The substrate support system of claim 1, wherein the substrate holder comprises an annular shoulder surrounding the interior portion, the shoulder defining a substrate pocket adapted to receive a substrate of said particular size, the shoulder configured to closely surround an outer edge of a substrate of said particular size received within the pocket, such that the substrate is in said supported position.

24. A substrate support system comprising a substrate holder for supporting a substrate, the substrate holder having a mass density that varies along a radius from a center of the substrate holder to an outer perimeter of the substrate holder, wherein the substrate holder is formed of a porous material having a porosity between about 10%-40% and configured to allow gas flow therethrough.

25. The substrate support system of claim 24, wherein the variation of the mass density is caused by a variation of the porosity of the material.

26. The substrate support system of claim 24, wherein the substrate holder includes recesses defining thinned portions of the substrate holder, each of the thinned portions being no thicker than 90% of a thickness of the substrate holder immediately surrounding the recess defining the thinned portion.

27. The substrate support system of claim 26, wherein the variation of the mass density is caused by a variation of a density of the recesses along the radius of the substrate holder.

28. The substrate support system of claim 26, wherein the variation of the mass density is caused by a variation of sizes of the recesses along the radius of the substrate holder.

29. The substrate support system of claim 24, wherein the substrate holder comprises a central circular region having a substantially uniform first mass density and an annular region surrounding the central region, the annular region having a substantially uniform second mass density that is different than the first mass density.

30. The substrate support system of claim 24, wherein an upper surface of the substrate holder is concave.

31. A substrate support system comprising a substrate holder for supporting a substrate of a particular size in a defined supported position, the substrate holder comprising holes extending to and between upper and lower surfaces of the substrate holder, the substrate holder having a point configured to vertically align with a center of the particularly sized substrate when the substrate is in the supported position, wherein the substrate holder has a mass density that decreases along a radius from the point to an outer annular location of the substrate holder.

32. The substrate support system of claim 31, wherein the decrease of the mass density along the radius is caused by a variation of a density of the holes along the radius.

33. The substrate support system of claim 32, wherein the holes are all of a substantially equal size.

34. The substrate support system of claim 31, wherein the decrease of the mass density is continuous from the point to the outer annular location.

35. The substrate support system of claim 31, wherein the substrate holder comprises a central circular region having a substantially uniform first hole density and an annular region surrounding the central region, the annular region having a substantially uniform second hole density that is different from the first hole density.

36. The substrate support system of claim 31, wherein each of the holes in the substrate holder has only one upper end at the upper surface of the substrate holder and only one lower end at the lower surface of the substrate holder, wherein none of the holes are connected to any others of the holes.

37. The substrate support system of claim 31, wherein the decrease of the mass density is caused by a variation of a size of the holes along the radius.

38. The substrate support system of claim 37, wherein the mass density is greater near the point than near the outer annular location.

39. The substrate support system of claim 31, wherein the substrate holder comprises a central circular region having holes of a substantially uniform first size and an annular region surrounding the central region, the annular region having holes of a substantially uniform second size that is different than the first size.

40. The substrate support system of claim 31, wherein the upper surface of the substrate holder is concave.
